(19) United States
(12) Patent Application Publication
(10) Pub. No.: US 2021/0070464 A1
(43) Pub. Date: Mar. 11, 2021

(54) FUEL BOOST PUMP ASSEMBLY FOR AN AIRCRAFT

(71) Applicant: Eaton Intelligent Power Limited, Dublin 4 (IE)

(72) Inventors: Alan Massey, Southampton Hampshire (GB); Manoj Kakade, Pune (IN); Surendrababu Yadav, Andhrapradesh (IN); Vismay Walle, Pune (IN); Ankita Deshpande, Pune (IN); Subrata Sarkar, Pune (IN); Pradeep Biradar, Pune (IN); Arindam Ghosh, Pune (IN)

(21) Appl. No.: 17/053,379

(22) PCT Filed: May 8, 2019
(86) PCT No.: PCT/EP2019/061817

§ 371 Date: Nov. 6, 2020

(30) Foreign Application Priority Data
May 8, 2018 (IN) 201811017351
Jul. 26, 2018 (GB) 1812205.1

(51) Int. Cl. B64D 37/00; F02M 37/12; F04D 13/04; F23K 5/14

(52) U.S. Cl. CPC B64D 37/005; F02M 37/12; F04D 1/04; F04D 13/046; F23K 5/145; F04D 13/043

(57) ABSTRACT

A fuel boost pump assembly for an aircraft includes a first inlet for receiving a first pressurized fuel flow, a second inlet, an assembly outlet, a pump for transferring fuel between the second inlet and the assembly outlet, and a hydraulic motor adapted to drive the pump. The hydraulic motor is fluidly connected between the first inlet and the assembly outlet, and is mechanically coupled to the pump. Further, in use, the hydraulic motor converts hydraulic energy of the first pressurized fuel flow into driving energy of the pump such that the pump generates a second pressurized fuel flow between the second inlet and the assembly outlet.

### CROSS-REFERENCE TO PRIOR APPLICATIONS

This application is a U.S. National Phase application under 35 U.S.C. § 371 of International Application No. PCT/EP2019/061817, filed on May 8, 2019, and claims benefit to British Patent Application No. GB 1812205.1, filed on Jul. 26, 2018 and to Indian Patent Application No. IN 201811017351, filed on May 8, 2018. The International Application was published in English on Nov. 14, 2019 as WO/2019/215228 under PCT Article 21(2).

### FIELD

The present invention relates to a fuel boost pump assembly for an aircraft and to an aircraft fuel system including at least one fuel boost pump.

### BACKGROUND

Aircraft fuel boost pumps are an essential part of aircraft fuel systems. Aircraft fuel systems typically comprise an engine-driven high pressure fuel pump, and an electrically-driven low pressure fuel boost pump. The function of the fuel pumps is to deliver a continuous supply of fuel to the engine (s) of the aircraft; whereas boost pumps are used to maintain positive pressure in the fuel lines to allow the engines to start. Boost pumps can also be used to redistribute fuel between tanks to equalize aircraft load, or prevent fuel tanks from running dry. They can also be used as an emergency pump in case of failure of the engine-driven fuel pump or to jettison fuel. Traditionally, aircraft use electrically-driven fuel boost pumps which are installed in the fuel tanks to supply fuel to the engine fuel supply system.

The engine fuel system typically comprises a two stage pump system: a first stage centrifugal pump, which receives the fuel supplied by the aircraft boost pumps, and a second stage high pressure (HP) pump, typically a gear pump, which provides high pressure fuel to the engine flow metering unit (FMU) which meters fuel to the engine combustion chamber in response to pilot power demand.

These systems have been developed over the years to provide high reliability and fault tolerance, in spite of fundamental drawbacks in overall efficiency. Although gear pumps provide a reliable source of high pressure fuel of typically above 9.65 MPa (1400+ psi), they are sized to meet either the take-off flow and speed or the windmill engine re-start flow and speed. This means that, at other engine power settings, the HP pump is oversized, resulting in the need to spill HP fuel back to first stage pump pressure conditions. Although some of the HP fuel energy is used for engine actuation, much of the pressure energy is converted to heat which results in losses of efficiency.

The electrically-driven fuel boost pumps have electrical motors which are fuel cooled. To minimize safety problems, the windings contain thermal fuses which break the current flow during an over-temperature event, and the pump cases incorporate flame traps which prevent hot gas entering the fuel tank in the unlikely event of an internal explosion caused by an electrical short and/or loss of coolant.

Furthermore, the effect of variable frequency (VF) electrical supply on aircraft boost pump operation now requires electronic power conditioning to maintain a constant voltage/frequency required by induction motors. Alternatively, variable slip induction motors may be used in some circumstances but at the expense of efficiency. The fact that power conditioners also require cooling makes it convenient to integrate pump, motor and power conditioner in one unit located within the tank. This however increases the safety risks, installation volume, weight, reduces reliability and, ultimately, increases costs.

### SUMMARY

In an embodiment, the present invention provides a fuel boost pump assembly for an aircraft, the assembly comprising: a first inlet for receiving a first pressurized fuel flow; a second inlet; an assembly outlet; a pump for transferring fuel between the second inlet and the assembly outlet; and a hydraulic motor adapted to drive the pump, the hydraulic motor being fluidly connected between the first inlet and the assembly outlet, and mechanically coupled to the pump, wherein, in use, the hydraulic motor converts hydraulic energy of the first pressurized fuel flow into driving energy of the pump such that the pump generates a second pressurized fuel flow between the second inlet and the assembly outlet.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a cross-section of the fuel boost pump assembly according to a first embodiment of the present invention;

FIG. 2 shows a perspective view of the fuel boost pump assembly of FIG. 1;

FIG. 3 shows an exploded view of the fuel boost pump assembly of FIGS. 1-2;

FIG. 4 shows a cross-section of the fuel boost pump assembly according to a second embodiment of the present invention;

FIG. 5 shows a side view of the fuel boost pump assembly according to a third embodiment of the present invention;

FIG. 6 shows a cross-section of the fuel boost pump assembly of FIG. 5;

FIG. 7 shows a perspective view of the fuel boost pump assembly of FIGS. 5-6;

FIG. 8 shows a perspective view of the fuel boost pump assembly of FIG. 7 with a top cover removed;

FIG. 9 shows an impeller of the pump connected with the gears of the gear motor in the assembly of FIGS. 5-8; and

FIG. 10 shows shafts and gears of the fuel boost pump assembly of FIGS. 5-9.

### DETAILED DESCRIPTION

Embodiments of the present invention seek to provide an aircraft fuel boost pump which overcomes one or more of the above disadvantages of conventional aircraft fuel boost pumps.

According to a first aspect of the present invention there is provided a fuel boost pump assembly for an aircraft, the assembly comprising a first inlet for receiving a first pressurized fuel flow; a second inlet (which is configured to receive relatively unpressurised fuel), an assembly outlet, a pump for transferring fuel between the second inlet and assembly outlet, a hydraulic motor adapted to drive the pump, the motor being fluidly connected between the first inlet and the assembly outlet, and mechanically coupled to the pump, wherein, in use, the hydraulic motor converts the hydraulic energy of the first pressurized fuel flow into driving energy of the pump such that the pump generates a second pressurized fuel flow between the second inlet and the assembly outlet.

Advantageously, the fuel boost pump of embodiments of the invention do not require an electrical supply in order to operate; rather the pump's motive force is provided solely from energy which is available within the engine fuel system. Specifically, embodiments take advantage of “spill” pressure of fuel being returned to the aircraft fuel system when maximum flow to the engine is not required, which would normally be “wasted” energy within the fuel system. Effectively embodiments of the invention enable the operation of the engine driven fuel system and the aircraft fuel boost system to be combined in order to harmonize operation and improve overall system efficiency. Thus, embodiments enable the conventional electrically-driven low pressure fuel boost pump to be replaced with a low pressure fuel boost pump which is driven by the energy of the pressurized fluid within the fuel system (resulting from the engine-driven high pressure fuel pump).

The elimination of electrical power to the fuel boost pump provides additional advantages for example eliminating the requirement for an electric motor, power conditioner and supply cables leading to increased safety from reduced electrical hazards. Since the pump does not require electric supply, it can be operated in situations of emergencies where the electric supply is interrupted thereby increasing the reliability of the aircraft fuel system.

In an embodiment, the pump comprises an impeller which is mechanically coupled with the hydraulic motor via a common shaft.

In an embodiment, the hydraulic motor and the pump are imperviously separated using an isolation plate.

In an embodiment, the assembly outlet is adapted such that, in use, an exhaust fuel flow from the hydraulic motor and the second pressurized fuel flow merge at the assembly outlet.

In an embodiment, the assembly further comprises a casing having a top portion, middle portion comprising the hydraulic motor and bottom portion comprising the impeller.

In an embodiment, the hydraulic motor comprises a Francis turbine and the first inlet is adapted to receive the first pressurized fuel flow comprising a pressure between substantially 50 pound-force per square inch (psig) (340 kilo Pascal (kPa)) and 150 psig (1035 kPa).

In an embodiment, the Francis turbine comprises a rotor which is coaxial with the impeller on the common shaft, and, in use, the first pressurized fuel flow drives the rotor which in turn rotates the impeller of the pump via the common shaft.

In an embodiment, the hydraulic motor comprises a Tesla turbine and the first inlet is adapted to receive the first pressurized fuel flow comprising a pressure of less than or equal to substantially 1400 psig (9.5 mega Pascal (MPa)). For example the turbine and/or inlet may be adapted to receive pressurized fuel flow at a pressure of approximately 1000 psig (6.8 MPa) to 1400 psig (9.5 MPa) Advantageously, a Tesla turbine is able to operate with a high head of fuel and/or at high temperature without cavitation issues; in contrast this is a significant constraint in the use of jet pumps for similar applications.

In an embodiment, the assembly further comprises a cylindrical casing, wherein the first inlet is disposed within the casing substantially perpendicularly to at least two disks of the Tesla turbine.

In an embodiment, the at least two disks are coaxial with the impeller on the common shaft, and, in use, the first pressurized fuel flow is tangentially injected onto an outer periphery of the at least two disks so as to drive the at least two disks which in turn rotate the impeller of the pump via the common shaft.

In an embodiment, the pump is adapted to generate the second pressurized fluid flow using the impeller and a diffuser disposed within the casing.

In an embodiment, the assembly further comprises two spiral-grooved bearings attached to the shaft.

In an embodiment, the hydraulic motor comprises a gear motor and the first inlet is adapted to receive the first pressurized fuel flow comprising a pressure of at least 400 psig (2.8 MPa), for example a pressure between approximately 400 psig (2.8 MPa) and 600 psig (4.1 MPa).

In an embodiment, the shaft comprises a splined shaft and the gear motor comprises at least one gear, wherein the at least one gear is coaxial with the impeller on the splined shaft, and, in use, the first pressurized fuel flow drives the at least one gear which in turn rotates the impeller of the pump via the splined shaft.

In an embodiment, the assembly further comprises a transfer conduit fluidly connected between the gear motor and the assembly outlet, the conduit being adapted to, in use, communicate an exhaust fuel flow from the gear motor to a discharge tube, wherein the exhaust fuel flow from the gear motor is discharged via the discharge tube and merges with the second pressurized fuel flow at the assembly outlet.

In an embodiment, the gear motor and the pump are imperviously separated.

In accordance with a second aspect of the present invention, there is provided an aircraft fuel system comprising at least one fuel boost pump assembly according to the first aspect.

In accordance with a third aspect of the present invention, there is provided an aircraft comprising a fuel system having at least one fuel boost pump assembly according to the first aspect.

Whilst the invention has been described above, it extends to any inventive combination set out above, or in the following description or drawings.

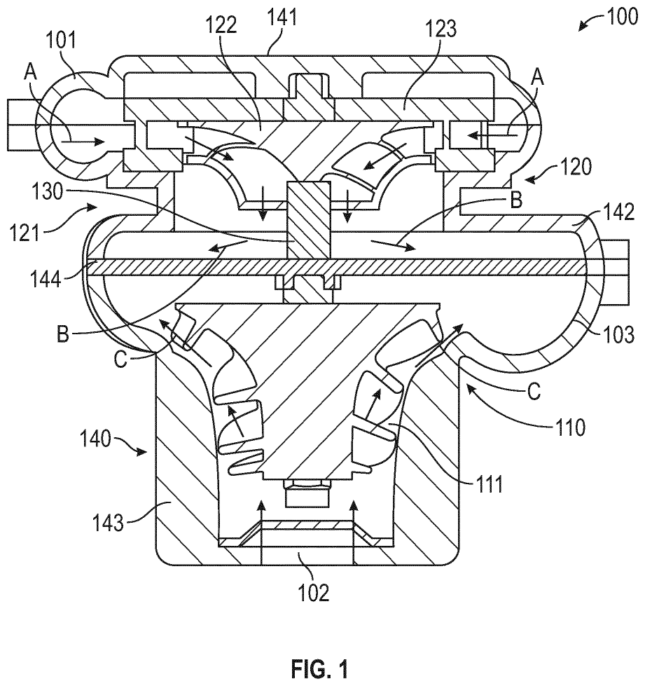

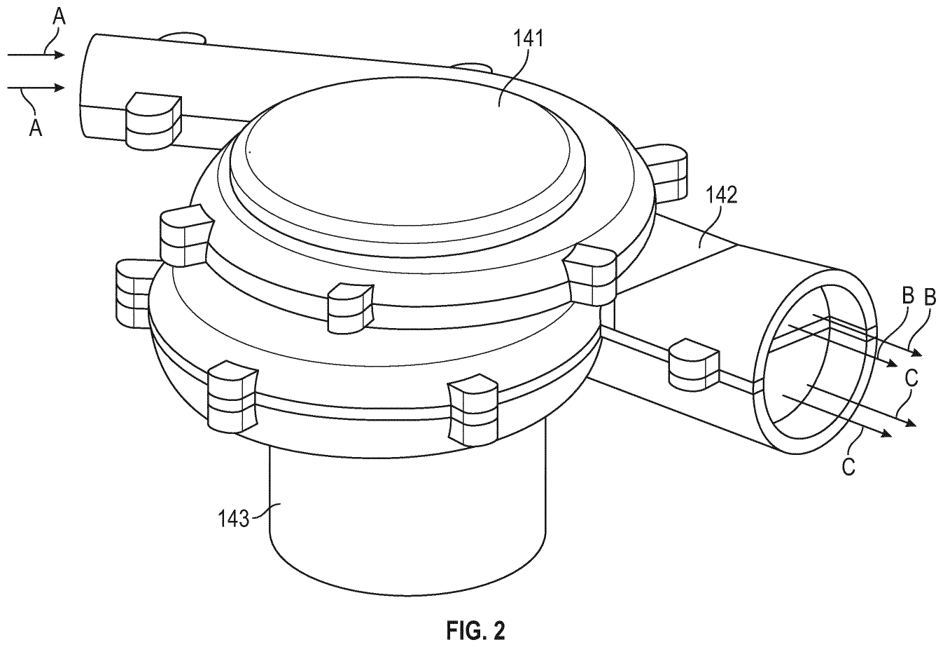

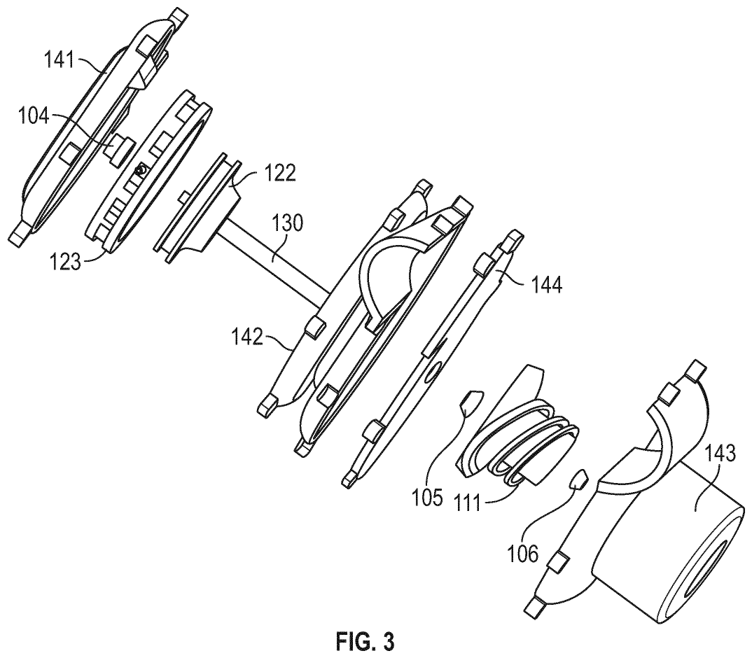

FIGS. 1 to 3 show a fuel boost pump assembly 100 in accordance with a first embodiment of the invention. The fuel boost pump assembly 100 comprises a first inlet 101, a second inlet 102, an assembly outlet 103, a pump 110 and a hydraulic motor 120. The pump 110 is adapted to transfer fuel between the second inlet 102 and assembly outlet 103. The hydraulic motor 120, which is mechanically coupled to the pump 110, is adapted to drive the pump 110, and is fluidly connected between the first inlet 101 and the assembly outlet 103.

The pump 110 may comprise an impeller 111, which may be mechanically coupled with the hydraulic motor 120 via a common shaft 130. The first inlet 101 is adapted to receive the first pressurized fuel flow and the hydraulic motor 120 converts the hydraulic energy of the first pressurized fuel flow into driving energy of the pump 110 such that the pump 110 generates a second pressurized fuel flow between the second inlet 102 and the assembly outlet 103.

In the first embodiment, as illustrated in the FIGS. 1 to 3, the hydraulic motor 120 may comprise a Francis turbine 121. The first inlet 101 may be adapted to receive the first pressurized fuel flow comprising a pressure between substantially 344 kPa (50 psig) and 1034 kPa (150 psig). It may be appreciated that fuel flow at such pressure may be available in the form of pressurized “spill fuel” from the Engine first stage pump. The turbine 121 may comprise a rotor 122 which may be coaxial with the impeller 111 on the common shaft 130. In use, the first pressurized fuel flow drives the rotor 122, which, in turn, rotates the impeller 111 of the pump 110 via the common shaft 130. The assembly outlet 103 may be adapted such that, in use, an exhaust fuel flow from the Francis turbine 121 and the second pressurized fuel flow merge at the assembly outlet 103.

The assembly 100 may further comprise a casing 140 enclosing the pump 110 and motor 120. The casing may also define the inlets 101, 102 and outlet 103 of the assembly 100. The casing 140 may have a top portion 141 comprising a stator 123 of the Francis turbine 121, middle portion 142 comprising the Francis turbine 121 and bottom portion 143 comprising the impeller 111, A bearing 104 may be attached to a first end of the shaft 130 which may be then be positioned substantially in the center of the stator 123. A corresponding bearing 105 may be positioned on the shaft such that the impeller 111 is separated from the isolation plate 144 by the bearing 105. A locking nut 106 is secured to the second end of the shaft 130. The Francis turbine 121 and the pump 110 can be imperviously separated using an isolation plate 144.

Advantageously, the casing 140 may be constructed of only three components (in contrast to many conventional pump casings which use 4 parts). To simplify manufacture, the top portion 141 and bottom portion 143 can be designed as a single piece, with the middle portion 142 positionable between the parts to form the final casing.

The assembly 100 may be operated as follows. A first stage centrifugal pump fuel spill flow A, having a pressure between approximately 340 kPa (50 psig) and 1040 kPa (150 psig) depending on the operating speed of the engine, is supplied to the Francis turbine 121 via the inlet 101. The pressurized fuel flow A then drives the rotor 122 which in turn rotates the impeller 111 of the pump 110 mounted on the same shaft 130. The rotation of the impeller 111 induces fuel from a fuel tank which generates a pressurized fuel flow C from the inlet 102 to the outlet 103. An exhaust fuel flow B leaving the turbine 121 and the pressurized fuel flow C merge at the outlet 103 of the assembly 100.

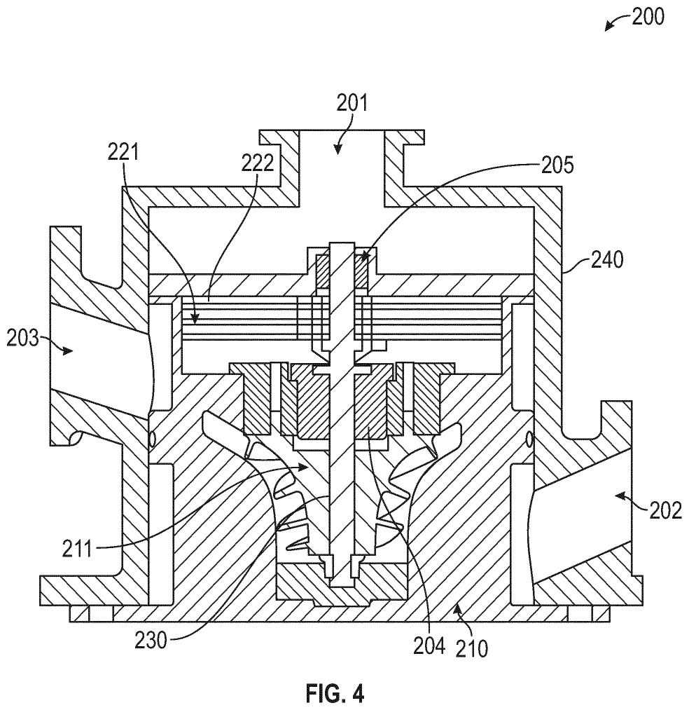

In a second embodiment, as illustrated in the FIG. 4, there is provided a fuel boost pump assembly 200 which comprises a Tesla turbine 221. It will be appreciated that this embodiment operates in a similar manner to the first embodiment but utilizes an alternate form of hydraulic motor. This embodiment may be optimized for use with a higher pressure fuel flow and the first inlet 201 is adapted to receive the first pressurized fuel flow comprising a pressure of at least 9.5 MPa (1400 psig). It may be appreciated that fuel flow at such pressure may be available in the form of pressurized “spill fuel” from the Engine high pressure fuel supply. The turbine 221 may comprise at least two disks 222 which may be metallic or non-metallic. Typically the turbine 221 will comprise a plurality of spaced apart parallel disks 222. The assembly 200 further comprises a substantially cylindrical casing 240, wherein the first inlet 201 is disposed within the casing 240 substantially perpendicularly to the at least two disks 222 of the Tesla turbine 221.

The at least two disks 222 may be coaxial with the impeller 211 on the common shaft 230. In use the first pressurized fuel flow [having relatively high pressure and low velocity) is received from the inlet 201 and is converted to an accelerated fuel flow (having relatively low pressure and high velocity) using at least one nozzle. The nozzle/nozzles are arranged to directed the accelerated flow such that it is tangentially injected onto an outer periphery of the at least two disks 222. The tangentially directed flow acts to drive the at least two disks 222 which in turn rotate the impeller 211 of the pump 210 via the common shaft 230. The pump 210 is adapted to generate the second pressurized fluid flow using the impeller 211 and a diffuser 203 disposed within the casing 240. Two spiral-grooved bearings 204, 205 may be attached to the shaft 230.

The assembly 200 may be operated as follows. A high-pressure gear pump spill fuel flow, comprising a pressure of less than or equal to substantially 9.5 MPa (1400 psig), enters into the turbine 221 via the inlet 201 and is then converted to an accelerated fuel flow (low pressure, high velocity) using the at least one nozzle. The accelerated fuel flow is then tangentially injected with high velocity on the outer periphery of the disk 222. The momentum of the high-velocity fuel flow generates a viscous drag torque on the impeller 211 causing its rotation. The high-velocity fuel flow then travels towards the center of the disk 222 due to viscous friction and exits therefrom. The rotation of the impeller 211 generates a pressurized fuel flow from the tank which enters via the inlet 202 and then exits via the outlet 203. An exhaust fuel flow from the turbine 221 and the pressurized fuel flow from the impeller 211 mix together and discharge through the outlet 203 to the engine feed line.

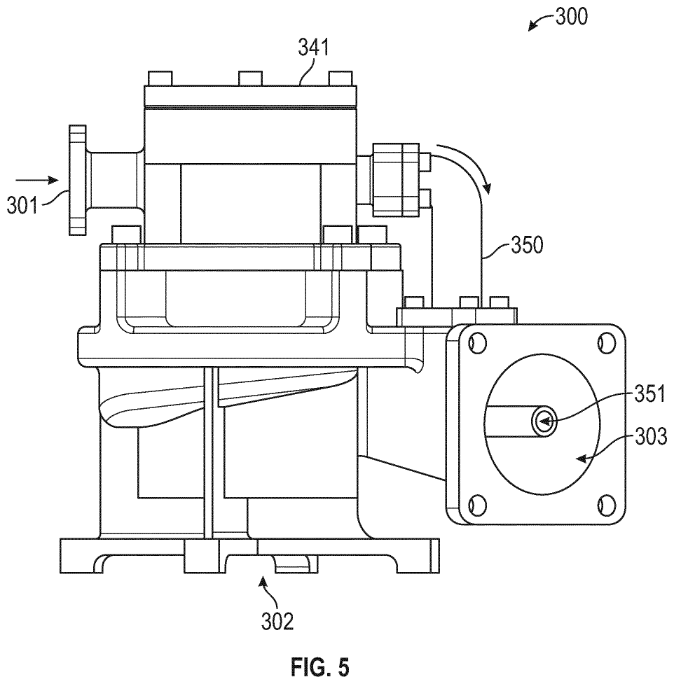

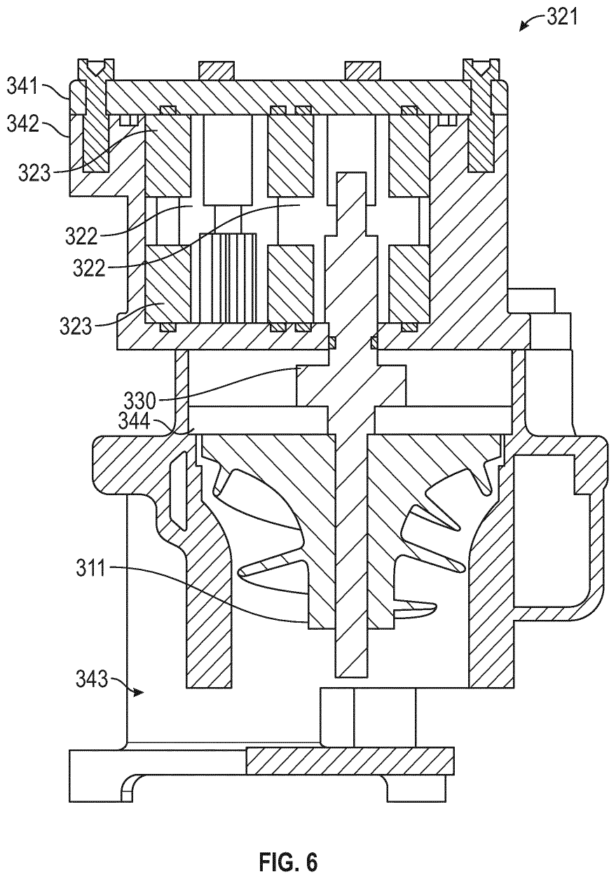

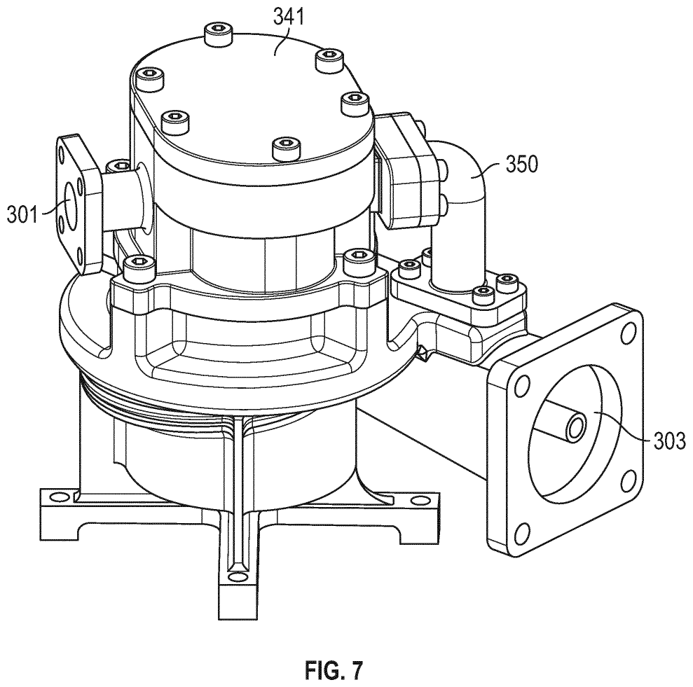

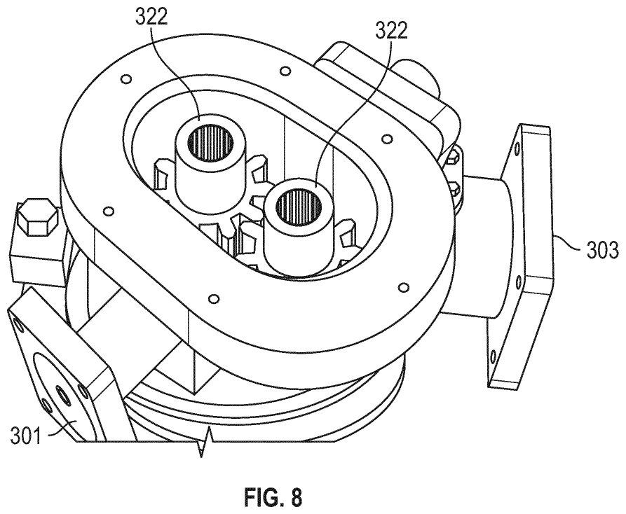

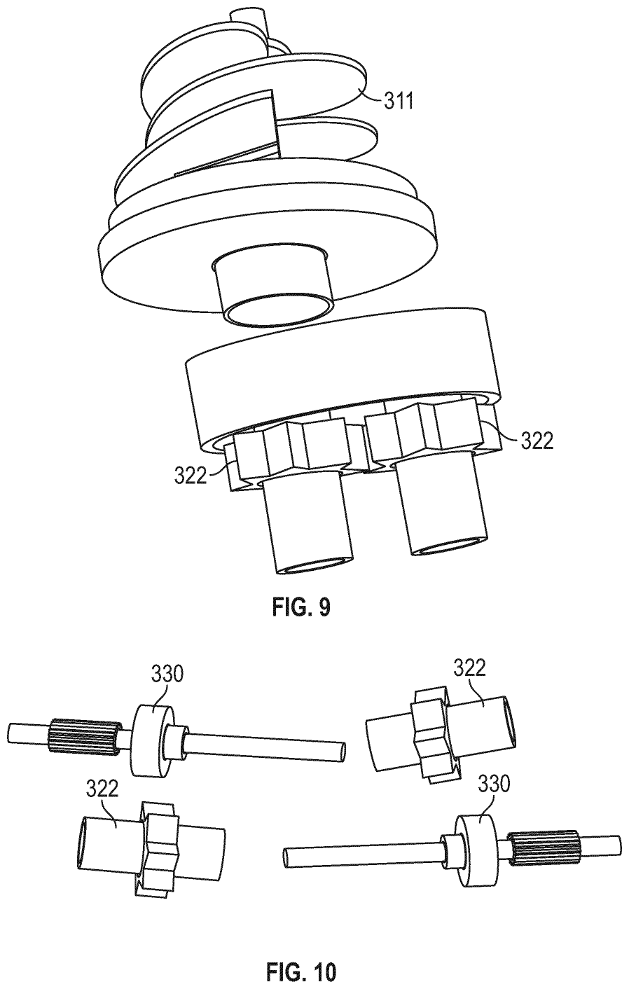

In a third embodiment, as illustrated in the FIGS. 5-10, there is provided a fuel boost pump assembly 300 which may comprise a hydraulic gear motor 321. It will again be appreciated that this embodiment operates in a similar manner to the previous embodiments but utilizes an alternate form of hydraulic motor. In this embodiment, the first inlet 301 adapted to receive the first pressurized fuel flow comprising a pressure between substantially 400 psig (2.8 MPa) to 600 psig (4.1 MPa).

The hydraulic gear motor 321 may comprises at least one gear 322, and as shown in the illustrated embodiment multiple gears (in this embodiment two) may be provided with one acting as an output and the other as an idler gear and both being driven by the pressurized flow in use. The output gear of the at least one gear 322 is connected to a shaft 330. The gear 322 and shaft 320 have a keyed connection, in the illustrated embodiment the shaft 330 comprises a splined shaft 330. The gear motor 321 comprises at least one gear 322 which is adapted to be received on the splined shaft. The impeller is coaxially mounted on the splined shaft 330. Accordingly, in use, the first pressurized fuel flow drives the at least one gear 322 which in turn rotates the impeller 311 of the pump 310 via the splined shaft 330. The at least one gear 322 may be positioned within respective bearing 323, which may be in a form of carbon block 323. A bearing 344 may also be provided between the gear motor 321 and the impeller 311 to support the shaft 330. A transfer conduit 350 may be provided and may be fluidly connected between the gear motor 321 and the assembly outlet 303. The conduit 350 may be adapted to, in use, communicate an exhaust fuel flow from the gear motor 321 to a discharge tube 351, wherein the exhaust fuel flow from the gear motor 321 is discharged via the discharge tube 351 and merges with the second pressurized fuel flow at the assembly outlet 303. The gear motor 321 and the pump 310 are imperviously separated.

The assembly 300 may be operated as follows. Pressurized spill fuel flow from the engine first stage pump is supplied to the inlet 301 of the gear motor 321. The pressurized fuel flow then drives the gears 322, which in turn rotate the impeller 311 of the pump 310 mounted on the same shaft 330. The rotation of the pump impeller 311 induces fuel flow from the fuel tank, pressurizes it and delivers it to the pump outlet 303. The exhaust fuel flow leaving the gear motor 321 via the transfer conduit 350 and the pressurized fuel flow from the pump 310 merges at the outlet 303.

Whilst the invention has been described above with reference to preferred embodiments, it will be appreciated that various changes or modifications may be made without departing from the scope of the invention as defined in the appended claims.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A fuel boost pump assembly for an aircraft, the assembly comprising:
a first inlet for receiving a first pressurized fuel flow;
a second inlet;
an assembly outlet;
a pump for transferring fuel between the second inlet and the assembly outlet; and
a hydraulic motor adapted to drive the pump, the hydraulic motor being fluidly connected between the first inlet and the assembly outlet, and mechanically coupled to the pump,
wherein, in use, the hydraulic motor converts hydraulic energy of the first pressurized fuel flow into driving energy of the pump such that the pump generates a second pressurized fuel flow between the second inlet and the assembly outlet.

2. The assembly according to claim 1, wherein the pump comprises an impeller that is mechanically coupled with the hydraulic motor via a common shaft.

3. The assembly according to claim 2, further comprising a casing having a top portion, a middle portion comprising the hydraulic motor, and a bottom portion comprising the impeller.

4. The assembly according to claim 1, wherein the hydraulic motor and the pump are imperviously separated using an isolation plate.

5. The assembly according to claim 1, wherein the assembly outlet is adapted such that, in use, an exhaust fuel flow from the hydraulic motor and the second pressurized fuel flow merge at the assembly outlet.

6. The assembly according to claim 1, wherein the hydraulic motor comprises a Francis turbine and the first inlet is adapted to receive the first pressurized fuel flow comprising a pressure between substantially 50 pound-force per square inch (psig) (340 kilo Pascal (kPa) and 150 psig (1035 kPa).

7. The assembly according to claim 6, wherein the Francis turbine comprises a rotor that is coaxial with an impeller on a common shaft of the pump, and, in use, the first pressurized fuel flow drives the rotor that in turn rotates the impeller of the pump via the common shaft.

8. The assembly according to claim 2, wherein the hydraulic motor comprises a Tesla turbine and the first inlet is adapted to receive the first pressurized fuel flow comprising a pressure of less than or equal to substantially 1400 pound-force per square inch (psig) (9.5 mega Pascal (Mpa)).

9. The assembly according to claim 8, further comprising a cylindrical casing, wherein the first inlet is disposed within the cylindrical casing substantially perpendicularly to at least two disks of the Tesla turbine.

10. The assembly according to claim 9, wherein the at least two disks are coaxial with the impeller on the common shaft, and, in use, the first pressurized fuel flow is converted into an accelerated fuel flow that is then tangentially injected onto an outer periphery of the at least two disks so as to drive the at least two disks that in turn rotate the impeller of the pump via the common shaft.

11. The assembly according to claim 9, wherein the pump is adapted to generate the second pressurized fuel flow using the impeller and a diffuser disposed within the cylindrical casing.

12. The assembly according to claim 8, further comprising two spiral-grooved bearings attached to the common shaft.

13. The assembly according to claim 2, wherein the hydraulic motor comprises a gear motor and the first inlet is adapted to receive the first pressurized fuel flow comprising a pressure between substantially 400 pound-force per square inch (psig) (2.8 mega Pascal (Mpa)) to 600 psig (4.1 MPa).

14. The assembly according to claim 13, wherein the common shaft comprises a splined shaft and the gear motor comprises at least one gear, wherein the at least one gear is coaxial with the impeller on the splined shaft, and, in use, the first pressurized fuel flow drives the at least one gear that in turn rotates the impeller of the pump via the splined shaft.

15. The assembly according to claim 13, further comprising a transfer conduit fluidly connected between the gear motor and the assembly outlet, the transfer conduit being adapted to, in use, communicate an exhaust fuel flow from the gear motor to a discharge tube, wherein the exhaust fuel flow from the gear motor is discharged via the discharge tube and merges with the second pressurized fuel flow at the assembly outlet.

16. The assembly according to claim 13, wherein the gear motor and the pump are imperviously separated.

17. An aircraft fuel system comprising:
at least one fuel boost pump assembly, wherein the at least one fuel boost pump assembly comprises:
a first inlet for receiving a first pressurized fuel flow;
a second inlet;
an assembly outlet;
a pump for transferring fuel between the second inlet and the assembly outlet; and
a hydraulic motor adapted to drive the pump, the hydraulic motor being fluidly connected between the first inlet and the assembly outlet, and mechanically coupled to the pump,
wherein, in use, the hydraulic motor converts hydraulic energy of the first pressurized fuel flow into driving energy of the pump such that the pump generates a second pressurized fuel flow between the second inlet and the assembly outlet.

18. An aircraft comprising:
a fuel system having at least one fuel boost pump assembly, wherein the at least one fuel boost pump assembly comprises:
a first inlet for receiving a first pressurized fuel flow;
a second inlet;
an assembly outlet;
a pump for transferring fuel between the second inlet and the assembly outlet; and
a hydraulic motor adapted to drive the pump, the hydraulic motor being fluidly connected between the first inlet and the assembly outlet, and mechanically coupled to the pump,
wherein, in use, the hydraulic motor converts hydraulic energy of the first pressurized fuel flow into driving energy of the pump such that the pump generates a second pressurized fuel flow between the second inlet and the assembly outlet.
